(19) United States
(12) Patent Application Publication
(10) Pub. No.: US 2008/0283179 A1
(43) Pub. Date: Nov. 20, 2008

(54) Device and Method for Printing Labels

(76) Inventor: John Richard Sink, Raleigh, NC (US)

Correspondence Address: MYERS BIGEL SIBLEY & SAJOVEC, PO BOX 37428, RALEIGH, NC, 27627, US

(21) Appl. No.: 11/927,865

(22) Filed: Oct. 30, 2007

Related U.S. Application Data
(60) Provisional application No. 60/938,869, filed on May 18, 2007.

(51) Int. Cl. B32B 38/14

(52) U.S. Cl. 156/192; 156/387; 156/249; 156/584

(57) ABSTRACT

A label printing station includes: a base; a label supply wheel rotatably mounted to the base for rotation about a first vertical axis of rotation; a label backing take-up wheel rotatably mounted to the base for rotation about a second vertical axis of rotation; and a label print-head assembly mounted to the base, the label print-head assembly being configured to print on a label as the label is vertically oriented. The supply wheel, the print-head assembly and the take-up wheel serially define a paper path along which a substantially continuous label backing sheet travels. The backing sheet may be supported from underneath at multiple locations along the paper path. With the printed label being vertically oriented, the label can be attached to an object, such as a vertically oriented pharmaceutical vial, which can simplify the labeling process.

### RELATED APPLICATION

This application claims priority from U.S. Provisional Patent Application No. 60/938,869, filed May 18, 2007 and entitled Device and Method for Printing Labels, the disclosure of which is hereby incorporated herein in its entirety.

### FIELD OF THE INVENTION

The present invention is directed generally to the dispensing of prescriptions of pharmaceuticals, and more specifically is directed to the automated dispensing of pharmaceuticals.

### BACKGROUND OF THE INVENTION

Pharmacy Generally began with the compounding of medicines, which entailed the actual mixing and preparing of medications. Heretofore, pharmacy has been, to a great extent, a profession of dispensing, that is, the pouring, counting, and labeling of a prescription, and subsequently transferring the dispensed medication to the patient. Because of the repetitiveness of many of the pharmacist's tasks, automation of these tasks has been desirable.

Some attempts have been made to automate the pharmacy environment. Different exemplary approaches are shown in U.S. Pat. No. 5,337,919 to Spaulding et al. and U.S. Pat. Nos. 6,006,946; 6,036,812 and 6,176,392 to Williams et al. The Williams system conveys a bin with tablets to a counter and a vial to the counter. The counter dispenses tablets to the vial. Once the tablets have been dispensed, the system returns the bin to its original location and conveys the vial to an output device. Tablets may be counted and dispensed with any number of counting devices. Drawbacks to these systems typically include the relatively low speed at which prescriptions are filled and the absence in these systems of securing a closure (i.e., a lid) on the container after it is filled.

One additional automated system for dispensing pharmaceuticals is described in some detail in U.S. Pat. No. 6,971,541 to Williams et al. This system has the capacity to select an appropriate vial, label the vial, fill the vial with a desired quantity of a selected pharmaceutical tablet, apply a cap to the filled vial, and convey the labeled, filled, capped vial to an offloading station for retrieval.

Although this particular system can provide automated pharmaceutical dispensing, certain of the operations may be improved. For example, the Williams system includes a first robotic carrier that receives a vial from a vial dispenser and conveys the vial to a label printer. The robotic carrier is configured to orient the vial to a horizontal disposition and to rotate the vial (via fingers inserted into the cavity of the vial) as the label printer presents the label. The robotic carrier then “hands off” the labeled vial to a second robotic carrier that conveys the labeled vial to tablet dispensing bins, a capping station, and an offload station. It may be desirable to simplify the system by reducing the number of robotic carriers.

### SUMMARY OF THE INVENTION

As a first aspect, embodiments of the present invention are directed to a label printing station for an object. The label printing station comprises: a base; a label supply wheel rotatably mounted to the base for rotation about a first vertical axis of rotation; a label backing take-up wheel rotatably mounted to the base for rotation about a second vertical axis of rotation; and a label print-head assembly mounted to the base, the label print-head assembly being configured to print on a label as the label is vertically oriented. The supply wheel, the print-head assembly and the take-up wheel serially define a paper path along which a substantially continuous label backing sheet travels. The label printing station further comprises a labeling station configured to apply a label to an object, the labeling station being positioned to receive a printed label from the print-head assembly and apply it to the object. With the printed label being vertically oriented, the label can be attached to a vertically oriented object, such as a pharmaceutical vial, which can simplify the labeling process.

As a second aspect, embodiments of the present invention are directed to a method of presenting a printed label for an object. The method comprises; conveying a label adhered to a substantially continuous label backing sheet past a print head assembly, the label and backing sheet being vertically oriented; printing pharmaceutical information on the label with the print head assembly as the label is vertically oriented; removing the vertically oriented printed label from the backing sheet for presentation to an object; and adhering the vertically oriented printed label to the object. Again, the vertical orientation of the label can facilitate the attachment to a vertically oriented object, such as a pharmaceutical vial.

As a third aspect, embodiments of the present invention are directed to a peel block for use with a label print-head assembly. The peel block comprises: a body section with opposed first and second side walls; at least one foot having an upper surface that defines a lower edge of a paper path followed by a backing sheet with labels adhered thereto, the foot extending from the first side wall; and at least one foot having an upper surface that defines a lower edge of the paper path, the foot extending from the second side wall. A peel block of this configuration can help to maintain a vertically-oriented label backing sheet in vertical alignment.

As a fourth aspect, embodiments of the present invention are directed to a method of presenting a printed label for an object, comprising: conveying a label adhered to a substantially continuous label backing sheet past a print head assembly, the label and backing sheet being vertically oriented; printing information on the label with the print head assembly as the label is vertically oriented; and removing the vertically oriented printed label from the backing sheet for presentation to an object. During the conveying step, the backing sheet is supported from underneath at multiple locations. This technique can facilitate proper application of a vertically oriented printed label to the object.

As a fifth aspect, embodiments of the present invention are directed to a label printing station for printing labels, comprising: a base; a label supply wheel rotatably mounted to the base for rotation about a first vertical axis of rotation; a label backing take-up wheel rotatably mounted to the base for rotation about a second vertical axis of rotation; and a label print-head assembly mounted to the base, the label print-head assembly being configured to print on a label as the label is vertically oriented. The supply wheel, the print-head assembly and the take-up wheel serially define a paper path along which a substantially continuous label backing sheet travels. The paper path includes multiple locations positioned to support the label backing sheet from underneath.

### BRIEF DESCRIPTION OF THE FIGURES

FIG. 1 is a flow chart depicting operations that can be carried out by an automated pharmacy machine according to embodiments of the present invention.

FIG. 2 is a front perspective view of an automated pharmacy machine according to embodiments of the present invention.

FIG. 3 is an opposite side front perspective view of the automated pharmacy machine of FIG. 2 with the outer skin removed to permit visual access to components housed therein.

FIG. 4 is a top, front perspective view of the label printing station employed by the automated pharmacy machine of FIG. 2 along with a top view of a label application station.

FIG. 5 is a top view of the label printing station of FIG. 4.

FIG. 6 is an exploded view of the supply wheel of the label printing station of FIG. 4.

FIG. 7 is a partial, top, front perspective view of the print-head assembly platen and peel block of the printing station of FIG. 4 showing the peeling of a printed label from the label backing sheet.

FIG. 7a is a partial bottom front perspective view of the printing section of the base plate of the label printing station in FIG. 4 showing the motor that drives the backing roll.

FIG. 8 is a front perspective view of the peel block of the label printing station of FIG. 4.

FIG. 9 is an opposite front perspective view of the peel block of FIG. 8.

FIG. 10 is a section view of the peel block taken along lines 10-10 of FIG. 12 showing the loading of a label backing sheet.

FIG. 11 is a section view of the peel block as in FIG. 10 showing how the label backing sheet is vertically aligned thereby.

FIG. 12 is an enlarged, top, rear perspective view of the take-up wheel and peel block of the label printing station of FIG. 4.

FIG. 13 is a bottom perspective view of the spindle unit and the clutch mechanism of the label printing station of FIG. 4.

FIG. 14 is a section view of the spindle unit and clutch mechanism of FIG. 13.

FIG. 15 is a bottom perspective view of the motor and clutch mechanism of the label printing station of FIG. 4.

FIG. 16 is an enlarged top perspective view of the upper end of the spindle of FIG. 13.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Also, as used herein, the terms “downstream” and “upstream,” which are often used in manufacturing environments to indicate that certain material being acted upon is farther along in the manufacturing process than other material, are intended to indicate relative positions of components along a path following by a substantially continuous paper sheet that travels along and through the components. A component that is “downstream” from another component means that the first component is positioned farther along the paper path, and a component that is “upstream” from another component means that the first component is nearer the origin of the paper path. It should be noted that, relative to an absolute x-y-z coordinate axis system, these directions shift as the paper is conveyed between different operations. When they occur, these shifts in absolute direction are noted hereinbelow, and the downstream direction is redefined with reference to structures illustrated in the drawings.

Well-known functions or constructions may not be described in detail for brevity and/or clarity.

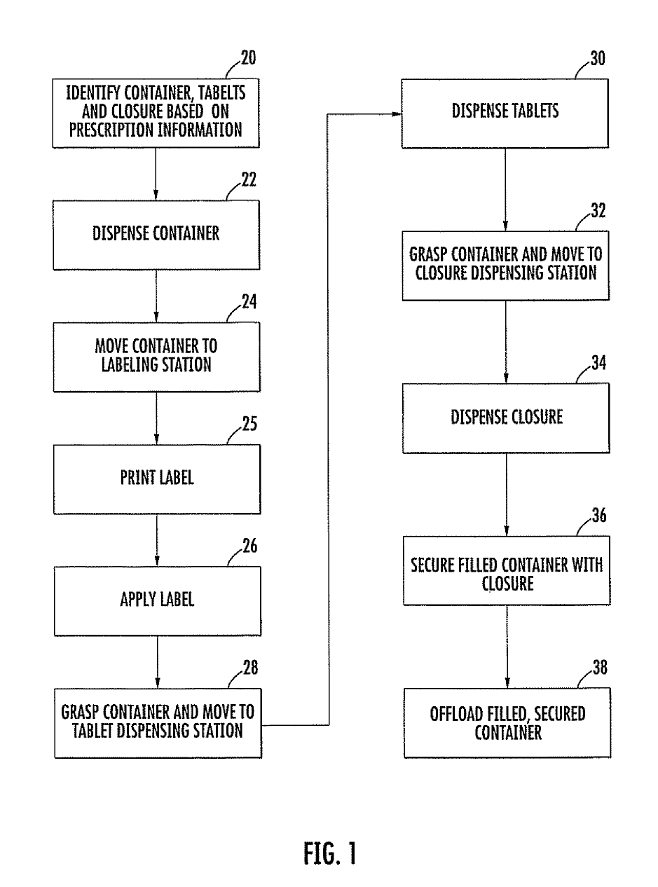

As described above, the invention relates generally to a system and process for dispensing pharmaceuticals. An exemplary process is described generally with reference to FIG. 1. The process begins with the identification of the proper container, tablets or capsules and closure to be dispensed based on a patients prescription information (Box 20). A container of the proper size is dispensed at a container dispensing station (Box 22), then moved to a labeling station (Box 24). A printing station prints a label (Box 25) that is applied at the labeling station (Box 26), after which the container is transferred to a tablet dispensing station (Box 28), from which the designated tablets are dispensed in the designated amount into the container (Box 30). The filled container is then moved to a closure dispensing station (Box 32), where a closure of the proper size has been dispensed (Box 34). The filled container is secured with a closure (Box 36), then transported to an offload station and offloaded (Box 38).

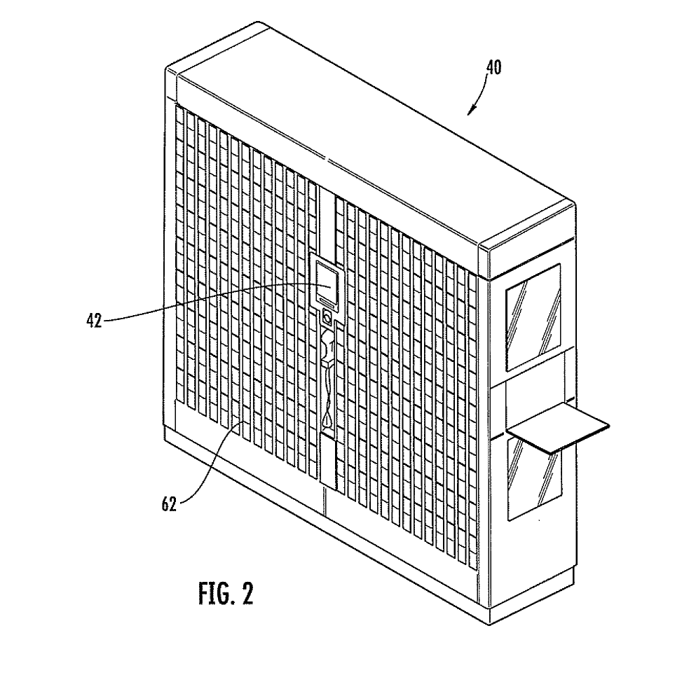

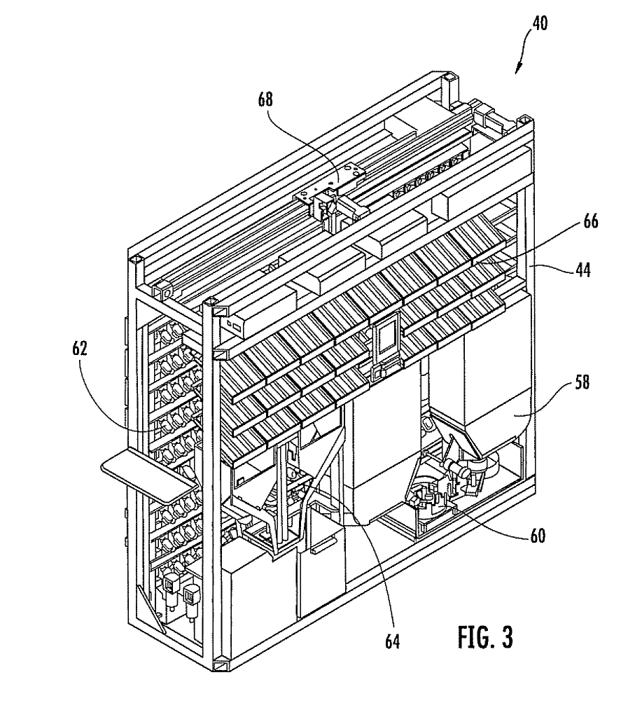

A system that can carry out this process is illustrated in FIGS. 2 and 3 and designated broadly therein at 40. The system 40 includes a support frame 44 for the mounting of its various components. The system 40 generally includes as operative stations a controller (represented herein by a graphics user interface monitor 42), a container dispensing station 58, a labeling station 60, a tablet dispensing station 62, a closure station 64, and an offloading station 66. In the illustrated embodiment, containers, tablets and closures are moved between these stations with a single carrier 68; however, in some embodiments only a single carrier may be employed, or one or more additional carriers may be employed. The operation of the container dispensing station 58, the tablet dispensing station 62, and the closure station 64, and the offloading station 66 are described in, for example, U.S. patent application Ser. Nos. 11/599,526; 11/599,576; 11/679,850; and 11/111,270, the disclosure of each of which is hereby incorporated herein in its entirety.

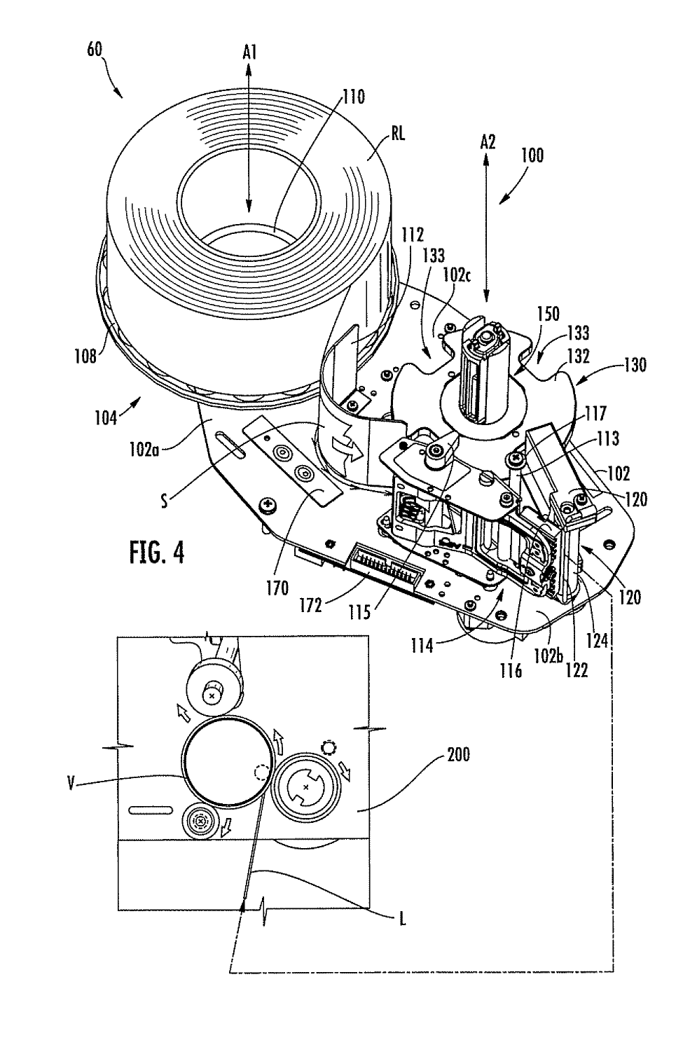

Turning now to FIG. 4, the labeling station 60 includes a label printing station 100 and a label application station 200. The label application station 200, which receives a label L from the label printing station 100 and applies the label L to a vial V, is described in some detail in co-pending U.S. patent application Ser. No. 11/599,576, listed supra, and need not be described in detail herein.

The label printing station 100 includes a flat base plate 102 that can be divided into a supply section 102a, a printing section 102b, and a take-up section 102c. A supply wheel 104 is rotatably mounted on the supply section 102a, a label print-head assembly 114 and a peel block 120 are mounted on the printing section 102b, and a take-up wheel 130 is mounted on the take-up section 102b. These components are described in detail below.

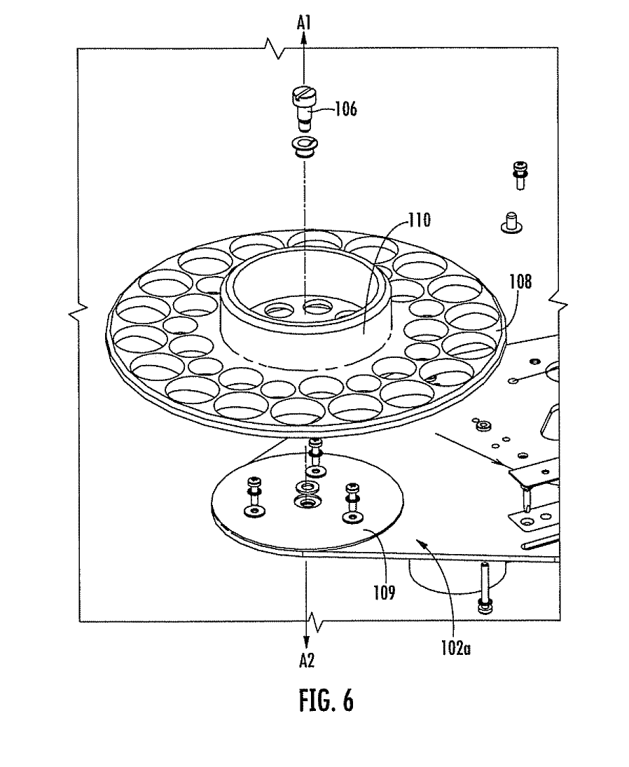

Referring to FIGS. 4-6, the supply wheel 104 includes an axle 106 that is inserted into the base 102 and extends substantially vertically therefrom. The axle 106 defines an axis of rotation A1. A bearing plate 109 is fixed to the base 102. A turntable 108 is mounted on the axle 106 and is free to rotate relative to the axle 106 about the axis of rotation A1. The underside of the turntable 108 engages the bearing plate 109 such that friction therebetween resists rotation of the turntable 108 about the axis A1. In some embodiments, the underside of the turntable 108 may have a rib that contacts the bearing plate 109 to provide friction and resist rotation. The turntable 108 includes a mounting ring 110 that is configured to fit within the central core of a reel of adhesive labels mounted on a label backing sheet.

Those skilled in this art will recognize that other configurations for a supply wheel may also be employed. For example, the turntable may be a solid piece, a foraminated piece as shown, or even a “spoked” piece. The turntable and mounting ring may be a single piece or separate pieces. The mounting ring may be replaced with upstanding prongs, projections or fingers that can engage the core of a reel of adhesive labels. The mounting ring may be formed of different materials, including polymeric materials or sheet metal; with embodiments formed of sheet metal, upstanding prongs and downwardly-extending ribs or projections may be formed in a stamping process. Also, the supply wheel may rely on a clutch or other friction-inducing mechanism that acts on either the turntable or the axle to induce rotational friction, such that the bearing plate may be omitted. Moreover, the supply wheel may lack a turntable altogether. Other embodiments may be apparent to those skilled in this art.

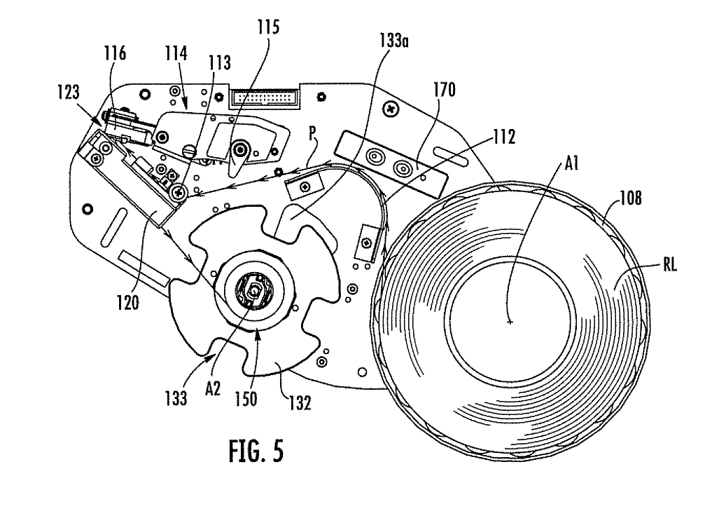

Turning now to FIGS. 4 and 5, a guide 112 is mounted to the base 102 between the supply wheel 104 and the print-head assembly 114. The guide 112 is undulated and projects away from the take-up wheel 130. A guide post 113 is mounted in the base 102 near the upstream end of the print-head assembly 114 and extends generally upwardly (see also FIG. 12). A static discharge brush 118 is mounted such that its bristles confront the guide post 113 (FIG. 12). The brush 118 is attached to a mounting guard 117. The mounting guard 117 is attached to the upper ends of both the guide post 113 and the print-head assembly 114, and its lower end engages a hole in the base plate 102. The brush 118 is mounted such that its bristles confront the guide post 113 (FIG. 12).

Turning now to FIGS. 4, 5, and 7, the print-head assembly 114 is mounted to the printer section 102b of the base 102 such that the printer head platen 116 is oriented to print on a vertical sheet. A release lever 115 is mounted on the upper surface of the print-head assembly 114 to enable a label sheet to be inserted and removed from the print-head assembly 114. An exemplary print-head assembly 114 is the Printing Assembly Part No. 91600104, available from APS Industrial (Milan, Italy).

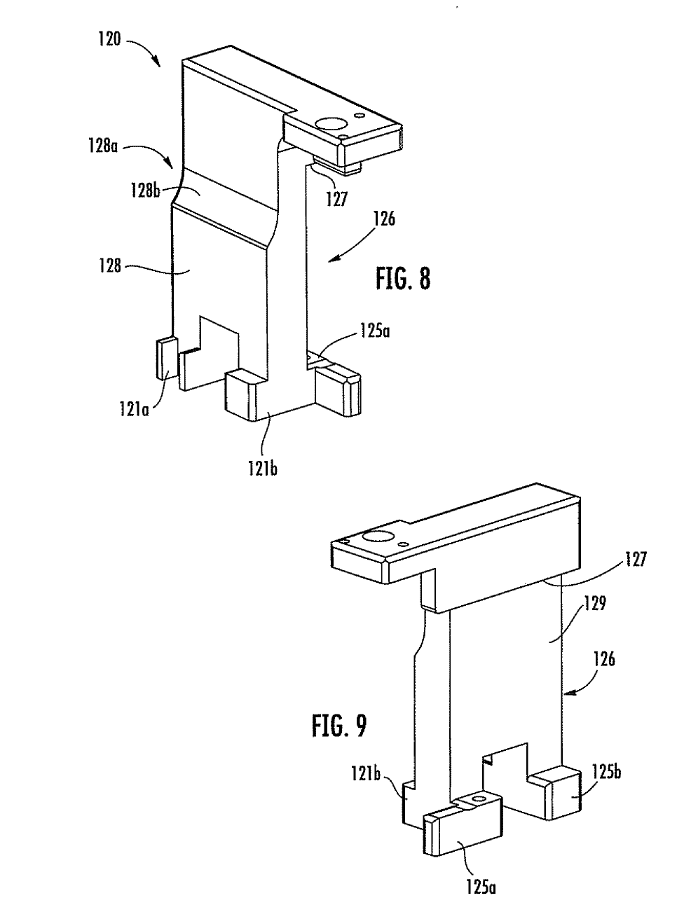

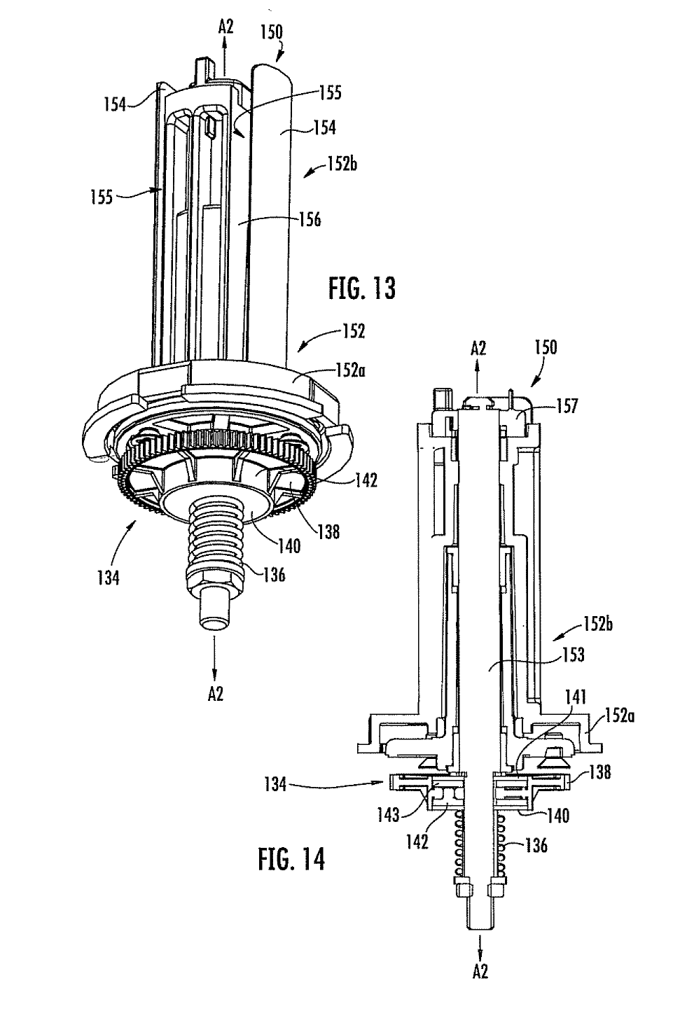

Referring now to FIGS. 8, 9 and 12, the peel block 120 is mounted to the printer section 102b of the base 102 such that it confronts the print-head assembly 114. The peel block 120 includes feet 121a, 121b that extend toward the print-head assembly 114 from a side wall 128; the foot 121a is positioned adjacent the guide post 113 (see FIG. 13), and the foot 121b is positioned just upstream of the printer head platen 116. The side wall 128 includes a recessed area 128a positioned above the feet 121a, 121b that has an arcuate surface 128b. A vertically oriented backing roll 124 (FIG. 12) is mounted in the peel block 120 adjacent the print-head assembly head 114 such that a nip 123 (FIG. 5) is formed therebetween. Also, a small diameter (0.040-0.150 inch) peel pin 122 (see FIG. 4) is vertically mounted to the peel block 120 just downstream of the printer head platen 116. On the opposite side wall 129 of the peel block 120, feet 125a, 125b extend away from the print-head assembly 114, as does a ledge 127, such that a pocket 126 is formed between the feet 125a, 125b and the ledge 127 (FIGS. 8 and 9).

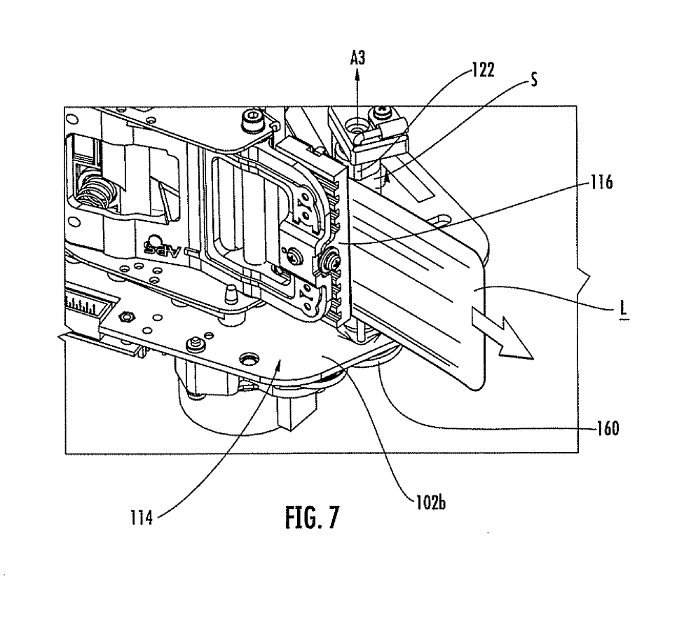

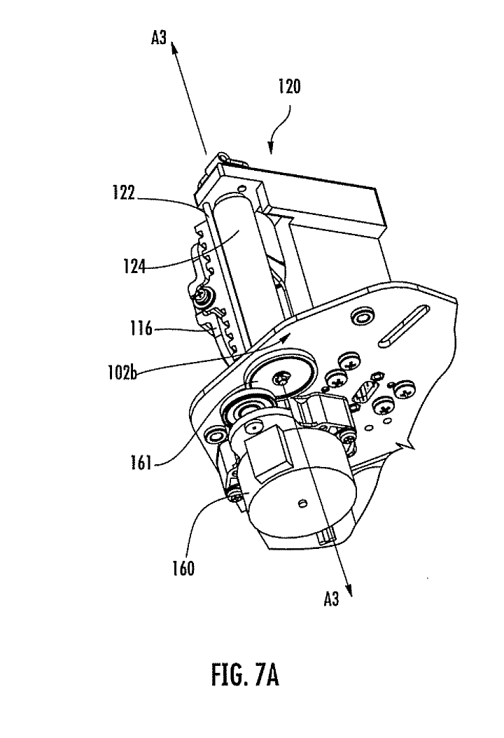

Referring now to FIG. 7a, the backing roll 124 is attached via an axle (not shown) to a gear 161 that engages a motor 160 mounted to the underside of the base plate 102. The backing roll 124 is rotatable about a generally vertical axis of rotation A3.

Those skilled in this art will appreciate that the peel block 120 may take different configurations with more or fewer feet, additional or fewer ledges and/or recessed areas, and the like. Also, the peel block 122 may be divided into upper and lower segments, which can be configured such that the distance between the feet 125a, 125b and the ledge 127 can be varied. As another alternative, the ledge 127 itself may be an insert that can be attached to the remainder of the peel block 120, such that changing the insert can adjust the vertical position of the ledge 127. Whether formed as a unitary or multi-component part, the peel block 120 may include features that receive the backing roll 124 and/or the peel pin 122, as well as the feet 121a, 121b, 125a, 125b, ledge 127, recessed area 128a and the like.

Turning now to FIGS. 4, 5 and 12, the take-up wheel 130 includes a turntable 132 rotatably mounted on a spindle unit 150. The turntable 132 is generally flat and includes four notches 133 that are generally circumferentially equidistant from each other. An access aperture 133a is positioned on an interior portion of the take-up section 102c of the base plate 102. As is the case with the turntable 108 of the supply wheel 104, the turntable 132 may take any number of configurations; in some embodiments, the turntable may be formed of a sheet metal, with structure for engaging the spindle unit 150 and the like being stamped into the turntable.

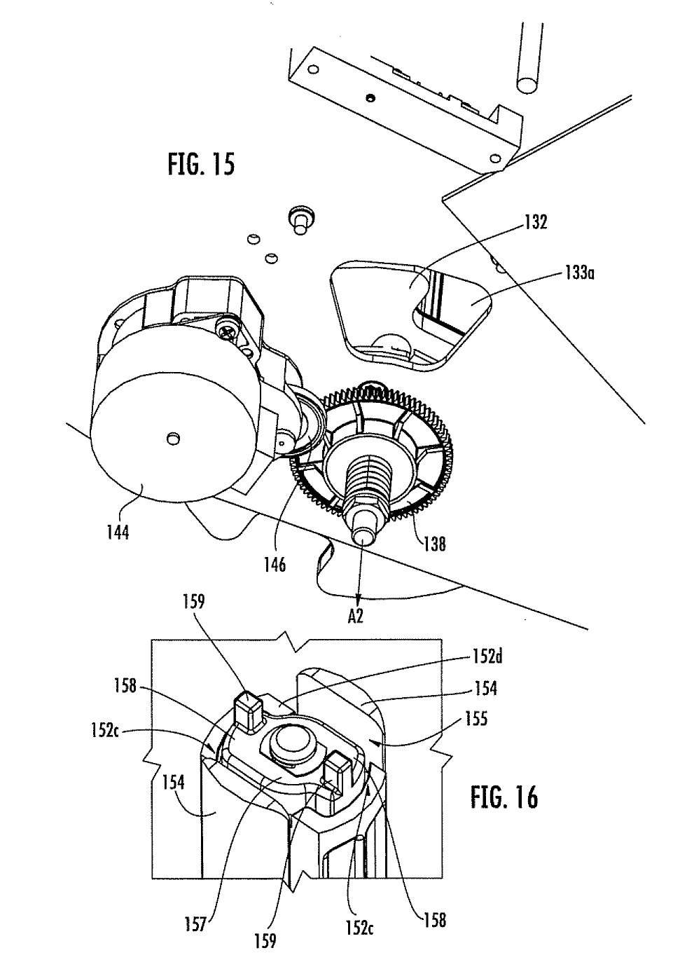

The turntable 132 is mounted to the spindle unit 150 via a base 152 (FIGS. 12-14). An axle 153 extends vertically through the base 152 to define an axis of rotation A2. On the underside of the base 102, a clutch mechanism 134 is attached to the axle 153 (FIGS. 13-15). The clutch mechanism 134 includes a pair of friction washers 140, 141 that are keyed to and rotate with the axle 153. A spring 136 applies upward pressure to the lower friction washer 140. The friction washers 140, 141 sandwich two bearing components 142, 143 that are keyed to and rotate with a gear 138 that receives, but is not restricted to rotate with, the axle 153. The gear 138 engages a gear reduction train 146 that in turn engages a motor 144 that is mounted to the underside of the base 102 (FIG. 15).

Referring now to FIGS. 13, 14 and 16, on the upper side of the base 102, the base 152 of the spindle unit 150 includes a mounting panel 152a and a tower 152b. The tower 152b has two vertical wings 154 on either side of a central shaft 156. The wings 154 and shaft 156 form two slots 155. The axle 153 extends upwardly through a bore in the tower 152b. A spreader 157 with radially-extending projections 158 is mounted to the upper end of the axle 153 (FIG. 16). Each of the projections 158 includes an upwardly-extending nub 159. The projections 158 reside in pockets 152e in the top surface of the tower 152b; each of the pockets 152c is bordered on one end by a finger 152d.

Further construction and operation of the spindle unit 150 is described at www.aps-printers.com, the disclosure of which is hereby incorporated herein by reference. An exemplary spindle unit is Part No. 91600103, available from APS Industrial (Milan, Italy). Those skilled in this art will appreciate that other rotary units suitable for driving the take-up wheel may also be employed.

Turning back to FIGS. 4, 5 and 15, the printing station 100 also includes a keypad 170 that is visible and accessible from the upper surface of the base 102 (in the illustrated embodiment, the keypad 170 is positioned near the guide 112, although those skilled in this art will appreciate that the keypad may be positioned in other locations on the base 102). A printed circuit board 172 that controls the operation of the printer station 100 is mounted below and in electrical communication with the keypad 170. The printed circuit board 172 controls the operation of the print-head assembly 114 and the motor 144 that drives the take-up wheel 130 and the motor 160 that drives the backing roll 124. The printed circuit board 172 is also in communication with the controller 42 of the overall system 40.

To prepare the printing station 100 for operation, a reel RL of labels L adhered to a rolled label backing sheet S is installed on the supply wheel 104, with the core of the reel RL fitting over the mounting ring 110 and the lower edge of the reel RL resting on the upper surface of the turntable 108. The labels L and label backing sheet S are well-known to those of skill in this art and need not be described in detail herein.

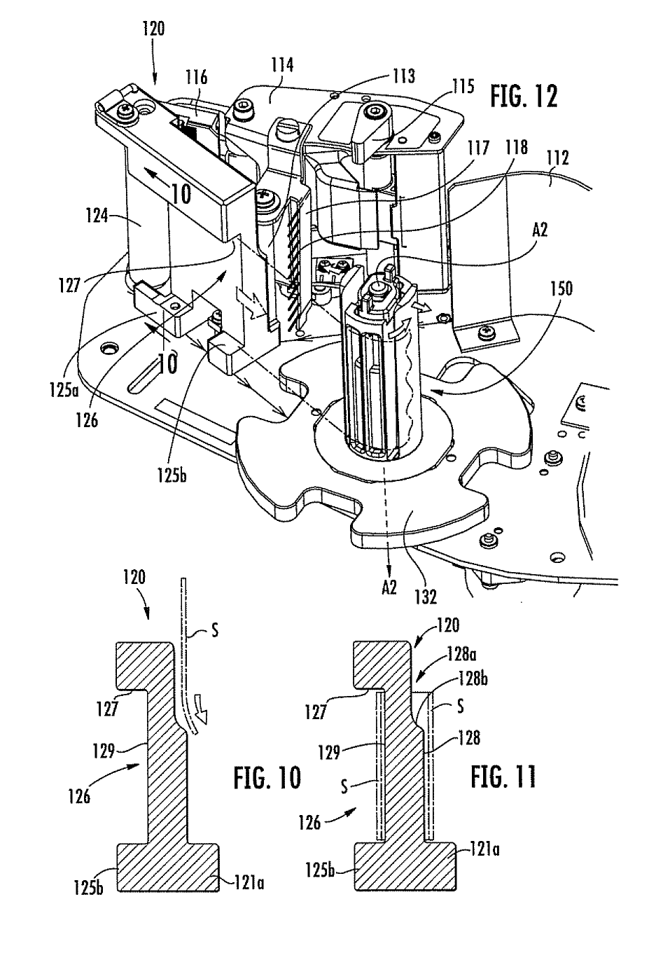

The label backing sheet S is threaded through the components of the printing station 100 along a paper path P that is defined by the supply wheel 104, the label print-head assembly 114, and the take-up wheel 130. Best seen in FIG. 5, the paper path P begins as the label backing sheet S extends from the supply wheel 104 around the convex surface of the guide 112 to form an undulation that extends away from the take-up wheel 130. The paper path P then travels to the brush 118, where static electricity can be dissipated from the label backing sheet S (the static electricity can be bled from the brush 118 by the mounting guard 117—see FIG. 12). The label backing sheet S is then routed around the guide post 113 (passing between the guide post 113 and the peeler block 120, as the mounting guard 117 prevents incorrect insertion between the guidepost 113 and the print-head assembly 114), then along the side wall 128 of the peeler block 120 to the nip 123 (insertion of the label backing sheet S between the side wall 128 and the print-head assembly 114 is facilitated by the presence of the recessed area 128a and the arcuate surface 128b see FIGS. 10 and 11). On this portion of the paper path P, the lower edge of the label backing sheet S is supported by the upper surfaces of the feet 121a, 121b, and the position of the upper edge of the label backing sheet S is maintained by the lower surface of the mounting guard 117. After passing through the nip 123 between the backing roll 124 and the print-head assembly 114, the paper path P veers around the peel pin 122 (see FIG. 7) and the back side of the backing roll 124 to pass into the pocket 126 (wherein the label backing sheet S is supported by the feet 125a, 125b and maintained in vertical position by the lower surface of the ledge 127 as shown in FIG. 12). A take-up segment of the paper path P then leads to the take-up wheel 130, where the label backing sheet S can be inserted into one of the slots 155 in the tower 152b and wound around the wings 154 and the outer surface of the tower 152b. Once the label backing sheet S is threaded onto the paper path P, the printing station 100 is ready for operation to form a substantially continuous component. As used herein, the term “substantially continuous” with respect to the label backing sheet indicates that it forms a continuous traveling sheet along the paper path P.

Because the paper path P doubles back on itself (i.e., the supply segment follows generally a first direction and the take-up segment follows generally a second, opposite direction—see FIG. 5), the printing station 100 can be relatively compact. Those skilled in this art will recognize that other paper paths are possible, and that the positions of the guides (e.g., the guide 112, the guide post 113, and the peel pin 122) may vary.

It should also be noted that the lower edge of the label backing sheet S is supported at several points along the entire paper path P in order to ensure correct feed of the label backing sheet S. Support of the label backing sheet S can prevent sagging of the label backing sheet S, which could disrupt its conveyance along the paper path P. In the illustrated embodiment, the specific surfaces which provide this support are: the top surface of the turntable 108, and the top surfaces of the feet 121a, 121b, 125a, and 125b, and the top surface of the turntable 132. These surfaces are all substantially coplanar, which allows them to provide support for the label backing sheet S from underneath at substantially the same elevation.

In operation, the controller 42 signals the printed circuit board 172 to actuate the take-up wheel 130 and the print-head assembly 114. The motor 144 drives the gear reduction train 146, which in turn rotates the gear 138 about the axis A1 (the rotation is clockwise from the vantage point of FIGS. 13 and 15). As the gear 138 rotates, the bearing components 142, 143 rotate also. Friction between the bearing components 142, 143 and their contacting friction washers 140, 141 causes the axle 153 to rotate (this rotation is counterclockwise from the vantage point of FIGS. 4 and 5). The spreader 157 rotates with the axle 153. As the projections 158 on the spreader 157 contact the wings 155, the upper ends of the wings 155 deflect outwardly, such that any label backing sheet S that is wrapped around the tower 152b is maintained in a cylindrical form. When the projections 158 contact the fingers 152d of the pockets 152c of the tower 152b, the tower 152b and, in turn, the entire base 152 and turntable 132, begin to rotate.

Rotation of the backing roll 124 (driven by the motor 160) draws the label backing sheet S from the supply reel RL along the paper path P to the peel pin 122. As the label backing sheet S, with its adhered labels L, passes through the nip 123, the print-head assembly 114 prints the desired information on a label L as it is vertically oriented. When the label backing sheet S veers along the paper path P around the peel pin 122 (see FIG. 12), the label L has enough rigidity to remain planar and peel away from the label backing sheet S. The label travels away from the nip 123 and adheres to a vertically-oriented pharmaceutical vial V that is presented by the label application station 200 (FIG. 4). In this embodiment, the forward edge of the label L adheres to the vial V before the rear edge of the label L is removed from the label backing sheet S.

The presence of the small diameter peel pin 122 can facilitate peeling of label L. In typical label printers, a sharp edge is employed in the peeling process; however, sharp edges have at least two inherent problems. Due to the sharp edge, a very high tension is required to keep the label backing tightly conformed against the edge as the label backing advances. If high tension is not maintained, or if the label backing catches on the sharp edge, a momentary condition may occur in which the label backing is continued to be pushed ahead by the backing roll 124, but is not immediately taken up by the spindle unit 152. This condition typically causes an instantaneous bulge of the label backing in the immediate vicinity of the sharp peeling edge, rendering the label peeling function of the edge momentarily ineffective. If the leading edge of a label is present when this condition occurs, the label will not peel as intended but will instead remain attached to the label backing where it will be conveyed to, and wrapped around, the spindle unit 152, thus preventing the label from being presented, as desired, to the label application mechanism. A round peeler pin 122, of sufficiently small diameter, can permit a lower label backing tension and eliminates the sharp edge which can snag the label backing.

A second advantage of the round peel pin 122 relates to the precision of location required of this feature. In order to reliably apply labels to vials, the label should be presented very consistently over many repetitions. This requires that the peeling edge be controlled very consistently from machine to machine. Sharp edges are most economically produced from formed sheet metal, typically attached with screws or other mounting hardware. The location of the peeling edge is typically affected by a number of tolerances: precision of the stamping and forming processes, hole locations in the peeler part and its mounting base, etc. By employing a round peel pin 122, which can be directly positioned by its diameter, the locating tolerances of the peeling surface can be significantly reduced over typical sharp-edged parts. More precise control of the location of the peeling surface can produce a direct improvement in the consistency of label presentation accuracy, which is desirable for successful label application on a vial.

Although rotation of the base 152 and turntable 132 are driven by the motor 144 as described, rotation of the base 152 and turntable 132 are restricted by tautness in the label backing sheet S extending from the print-head assembly 114. In some embodiments, the motor 144 causes the take-up wheel 130 to rotate at a speed that would cause the label backing sheet S to wind about the tower 152b faster than the speed at which the label backing sheet S exits the print-head assembly 114 (as controlled by the backing roll 124 driven by the motor 160); as a result, the friction washers 140, 141 slip on bearing components 142, 143 to reduce the rotational speed of the turntable 132 and tower 152b. Under these conditions, the label backing sheet S can remain substantially taut.

The supply wheel 104 can also assist in keeping the label backing sheet S taut upstream from the print-head assembly 114. The turntable 108 is free to rotate about the axis A1; however, friction between the turntable 108 and the bearing plate 109 resists this rotation sufficiently that, when the label backing sheet S and adhered labels L are not being drawn from the reel RL by the print-head assembly 114, the turntable 108 does not rotate. As a result, the supply segment of the label backing sheet S that extends from the roll to the print-head assembly 114 remains taut.

Once a reel RL of label backing sheet S is exhausted of labels L, the rolled label backing sheet that has collected on the take-up wheel 130 can be removed. Removal can be facilitated by the presence of the notches 133, which provide room for an operator's finger to fit beneath the rolled sheet, and the aperture 133a, which also provides access to the underside of the rolled sheet.

Those skilled in this art will recognize that, although the printing station 100 is illustrated and described herein with respect to an automated pharmaceutical machine, the printing station may be employed in other environments in which it may be desirable to present a vertically oriented label. Examples may include the labeling of jars, cans, barrels, and other cylindrical objects.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A label printing station for applying labels to an object, comprising:
a base;
a label supply wheel rotatably mounted to the base for rotation about a first vertical axis of rotation;
a label backing take-up wheel rotatably mounted to the base for rotation about a second vertical axis of rotation;
a label print-head assembly mounted to the base, the label print-head assembly being configured to print on a label as the label is vertically oriented;
wherein the supply wheel, the print-head assembly and the take-up wheel serially define a paper path along which a substantially continuous label backing sheet travels; and
a labeling station configured to apply a label to an object, the labeling station being positioned to receive a printed label from the print-head assembly and apply it to the object.

2. The label printing station defined in claim 1, wherein the paper path comprises a supply segment between the supply wheel and the label print-head assembly and a take-up segment between the label print-head assembly and the take-up wheel.

3. The label printing station defined in claim 2, wherein the supply segment of the paper path follows a first direction and the take-up segment follows a second direction from the label print-head assembly to the take-up wheel, the second direction being generally opposite the first direction.

4. The label printing station defined in claim 1, further comprising guides mounted to the base along the paper path configured and arranged to guide the continuous label backing.

5. The label printing station defined in claim 4, wherein a first guide is positioned and configured to induce an undulation in the paper path that projects away from the take-up wheel.

6. The label printing station defined in claim 1, wherein the supply wheel includes a turntable positioned to underlie a roll of label backing sheet and labels, the take-up wheel includes a turntable positioned to underlie a roll of label backing sheet, and the supply wheel turntable and the take-up wheel turntable are substantially coplanar.

7. The label printing station defined in claim 1, wherein the labeling station is positioned such that a forward edge of a printed label adheres to an object in the labeling station as a rearward edge of the printed label remains adhered to the label backing sheet.

8. A method of presenting a printed label for an object, comprising:
conveying a label adhered to a substantially continuous label backing sheet past a printer head, the label and backing sheet being vertically oriented; and
printing information on the label with the printer head as the label is vertically oriented;
removing the vertically oriented printed label from the backing sheet for presentation to an object; and
adhering the vertically oriented printed label to the object.

9. The method defined in claim 8, wherein the conveying step comprises rotating a take-up wheel that receives and rolls the backing sheet after the label has been removed, and further comprises providing a supply wheel, a roll of backing sheet and adhered labels mounted on the supply wheel, the backing sheet defining a paper path from the supply wheel to the printer head and subsequently to the take-up wheel.

10. The method defined in claim 8, wherein the supply wheel and the take-up wheel are rotated at a speed that causes the backing sheet to remain substantially taut.

11. The method defined in claim 8, wherein the adhering step comprises adhering a forward edge of the printed label to the object as a rear edge of the printed label remains attached to the backing sheet.

12. The method defined in claim 8, wherein the paper path comprises a supply segment between the supply wheel and the print-head assembly and a take-up segment between the print-head assembly and the take-up wheel, and wherein the supply segment of the paper path follows a first direction and the take-up segment follows a second direction that is generally opposite the first direction.

13. The method defined in claim 8, wherein the object is a pharmaceutical vial with a closed end thereof facing downwardly.

14. A peel block for use with a label printer, the peel block comprising;
a body section with opposed first and second side walls;
at least one foot having an upper surface that defines a lower edge of a paper path followed by a backing sheet with labels adhered thereto, the foot extending from the first side wall; and
at least one foot having an upper surface that defines a lower edge of the paper path, the foot extending from the second side wall.

15. The peel block defined in claim 14, further comprising a ceiling having a lower surface that defines an upper edge of the paper path that extends from the second side wall.

16. The peel block defined in claim 14, in combination with a vertically disposed backing roll that is mounted to the peel block.

17. A method of presenting a printed label for an object, comprising
conveying a label adhered to a substantially continuous label backing sheet past a print-head assembly, the label and backing sheet being vertically oriented; and
printing information on the label with the print-head assembly as the label is vertically oriented; and
removing the vertically oriented printed label from the backing sheet for presentation to an object;
wherein during the conveying step, the backing sheet is supported from underneath at multiple locations.

18. The method defined in claim 17, wherein the conveying step comprises rotating a take-up wheel that receives and rolls the backing sheet after the label has been removed, and further comprises providing a supply wheel, a roll of backing sheet and adhered labels mounted on the supply wheel, the backing sheet defining a paper path from the supply wheel to the print-head assembly and subsequently to the take-up wheel.

19. The method defined in claim 18, wherein at least one of the multiple support locations is positioned along the paper path between the supply wheel and the printer head, and at least another of the multiple support locations is located between the printer head and the take-up wheel.

20. The method defined in claim 18, wherein the supply wheel has a first turntable, wherein the take-up wheel has a second turntable, and wherein the first and second turntables are substantially coplanar.

21. The method defined in claim 18, wherein the object is a pharmaceutical vial.

22. A label printing station for printing labels, comprising:
a base;
a label supply wheel rotatably mounted to the base for rotation about a first vertical axis of rotation;
a label backing take-up wheel rotatably mounted to the base for rotation about a second vertical axis of rotation;
a label print-head assembly mounted to the base, the label print-head assembly being configured to print on a label as the label is vertically oriented;
wherein the supply wheel, the print-head assembly and the take-up wheel serially define a paper path along which a substantially continuous label backing sheet travels; and
wherein the paper path includes multiple locations positioned to support the label backing sheet from underneath.

23. The label printing station defined in claim 22, wherein the multiple locations are substantially coplanar.

24. The label printing station defined in claim 22, wherein the label supply wheel includes a first turntable, and wherein the label backing take-up wheel includes a second turntable, and wherein the first turntable and the second turntable are substantially coplanar.

25. The label printing station defined in claim 22, further comprising a labeling station configured to apply a label to a pharmaceutical vial, the labeling station being positioned to receive a printed label from the print-head assembly and apply it to a vial.
